(19) United States
(12) Patent Application Publication
(10) Pub. No.: US 2006/0086899 A1
(43) Pub. Date: Apr. 27, 2006

(54) Structure of image sensor package

(75) Inventors: Yeong-Ching Chao, Tainan (TW); An-Hong Liu, Tainan (TW); Yao-Jung Lee, Tainan (TW)

Correspondence Address: TROXELL LAW OFFICE PLLC, SUITE 1404, 5205 LEESBURG PIKE, FALLS CHURCH, VA, 22041, US

(73) Assignees: ChipMOS TECHNOLOGIES (Bermuda) LTD.; ChipMOS TECHNOLOGIES INC.

(21) Appl. No.: 11/254,676

(22) Filed: Oct. 21, 2005

(30) Foreign Application Priority Data
Oct. 21, 2004 (TW) 093216784

(51) Int. Cl. H01J 5/02

(52) U.S. Cl. 250/239

(57) ABSTRACT

An image sensor package comprises a carrier, an image sensor chip, and a transparent substrate where the carrier has a chip cavity and a plurality of first pads formed around the chip cavity. A plurality of bonding pads are formed on the active surface of the image sensor chip. The image sensor chip is disposed in the chip cavity. A plurality of probe leads are formed on the transparent substrate. The probe leads have a plurality of free tips. When the transparent substrate is adhered to the carrier, the image sensor chip is hermetically sealed, and the free tips are electrically contacted to the bonding pads of the image sensor chip, and the probe leads are electrically connected to the first pads of the carrier. The height variations of the image sensor chip in the chip cavity can be offset by the probe leads.

### FIELD OF THE INVENTION

The present invention relates to an image sensor package, and more particularly to an image sensor package with a plurality of probe leads on a transparent substrate.

### BACKGROUND OF THE INVENTION

Image sensor devices have been widely implemented in everyday lives such as cellular phones, personal digital assistants (PDA), digital still cameras (DSC), digital video cameras (DV), video phones, video conferences, and so on. As shown in FIG. 1, a conventional image sensor package comprises a substrate 11, a stiffener 12, an image sensor chip 13, a plurality of bonding wires 14, and a glass cover 15. The stiffener 12 is adhered to the substrate 11 to form a chip cavity. The image sensor chip 13 is attached to the upper surface of the substrate 11 in the chip cavity. The image sensor chip 13 is electrically connected to the substrate 11 by a plurality of bonding wires 14. The glass cover 15 is adhered to the stiffener 12 to hermetically seal the image sensor chip 13. Normally the glass cover 15 is an optical glass without any traces. Since the depth of the cavity formed by the substrate 11 and the stiffener 12 must be much larger than the thickness of the image sensor chip 13 and the loop height of the bonding wires 14, therefore, the overall package thickness of the image sensor package is very thick and can not be reduced.

Furthermore, a disclosed image sensor package is revealed in R.O.C. Taiwan patent publication No. 459355. An image sensor chip is flip chip bonded to a transparent substrate. A plurality of signal input terminals and a plurality of signal output terminals, which are formed on the different surfaces of the transparent substrate, are electrically connected to each other by side traces. The signal input terminals are used for electrically connect the image sensor chip, and the signal output terminals are used for mounting to a printed circuit board (PCB) having an opening. Therefore, the electrical transmission path is from the image sensor chip through the transparent substrate to the printed circuit board so that the transparent substrate has two basic criteria, good optical transparency and double side electrical transmission. However, it is very difficult to fabricate traces on double layers and sides of the transparent substrate. Accordingly, the fabrication cost is very high. Moreover, the image sensor chip is lack of protection. Another conventional image sensor package, as revealed in R.O.C. Taiwan patent publication No. 542493, entitled “image sensor structure”, comprises a substrate, a protrusion layer, an image sensor chip, and a light-transmission layer (glass cover). The image sensor chip is disposed in the chip cavity formed by the substrate and the protrusion layer. A plurality of signal input terminals are formed on the upper surface of the protrusion layer to provide electrical connections to the image sensor chip by a plurality of bonding wires. Then, through the circuit on the sidewalls of the protrusion layer and the sidewalls of the substrate, the electrical signals are transmitted to the substrate. An adhesive is partially disposed on the upper surface of the protrusion layer to adhere the light-transmission layer. However, during the packaging processes, the protrusion layer has to be formed on top of the substrate to form the chip cavity, which is very complicated. Whenever the thickness of the image sensor chip or the thickness of the protrusion layer changes, the loop height of the bonding wires is always higher than the upper surface of the protrusion layer. When the light-transmission layer is attached to the protrusion layer, the bonding wires will be damaged resulting in electrical short or open.

### SUMMARY OF THE INVENTION

The main purpose of the present invention is to provide an image sensor package using a transparent substrate with a plurality of probe leads. The probe leads have a plurality of free tips to contact the bonding pads of an image sensor chip during the step of hermetic sealing so that the variations of the thickness of the image sensor chip and the depth of the chip cavity can be offset by the probe leads.

According to the present invention, an image sensor package comprises a carrier, an image sensor chip, and a transparent substrate where the carrier has a first surface and a second surface. A chip cavity is formed in the first surface, and a plurality of first pads are formed on the first surface around the chip cavity. A plurality of second pads electrically connected to the first pads are formed on the second surface. The image sensor chip has an active surface and a back surface where a plurality of bonding pads are formed on the active surface. The back surface of the image sensor chip is attached to the first surface in the chip cavity. A plurality of probe leads are formed on the transparent substrate where the probe leads have a plurality of free tip to contact the bonding pads. When hermetically sealing the image sensor chip, the free tips electrically contact the bonding pads of the image sensor chip, and the probe leads are electrically connected to the first pads of the carrier. Accordingly, the variations of the thickness of the image sensor chip and the depth of the chip cavity can be offset by the probe leads.

### DESCRIPTION OF THE DRAWINGS

FIG. 1 is a cross-sectional view of a known image sensor package.

FIG. 2 is a cross-sectional view of an image sensor package according to the first embodiment of the present invention.

FIG. 3 is a cross-sectional view of an image sensor package according to the second embodiment of the present invention.

FIG. 4 is an enlarged cross-sectional view of the probe leads of the image sensor package according to the second embodiment of the present invention.

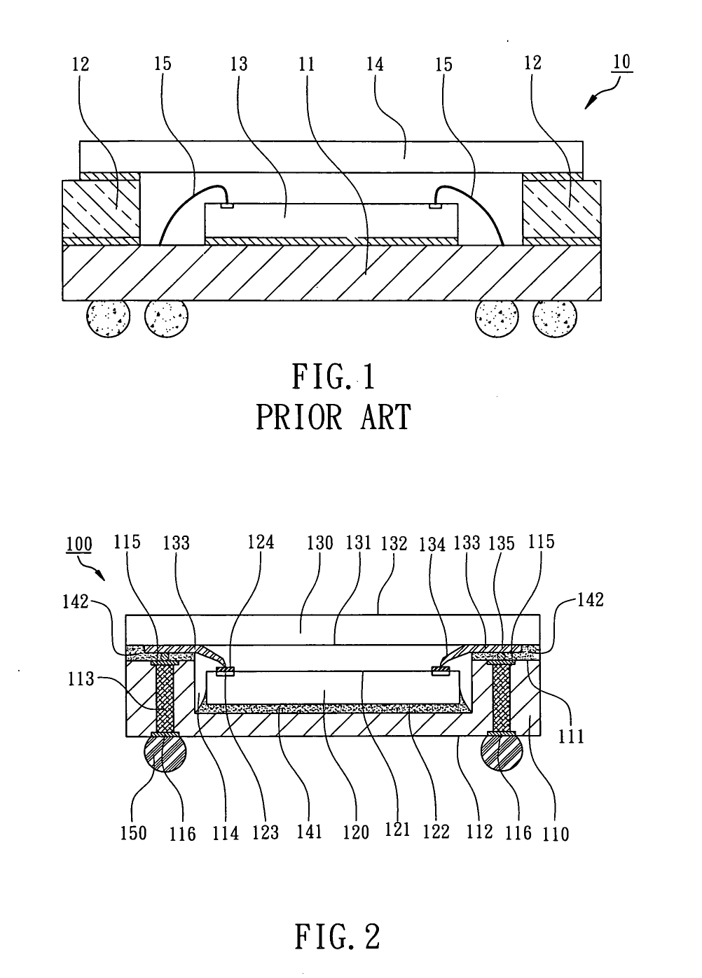

### DETAIL DESCRIPTION OF THE INVENTION

Please refer to the attached drawings, the present invention will be described by means of embodiments below.

In the first embodiment of the present invention, FIG. 2 shows an image sensor package 100. The package 100 includes a carrier 110, an image sensor chip 120, and a transparent substrate 130 where the material of the carrier 110 can be chosen from ceramic, BT, FR-4, or FR-5. The carrier 110 has a first surface 111, a second surface 112, and preferably, a plurality of plated through holes 113 (PTH) connecting the traces on the first surface 111 and on the second surface 112. A chip cavity 114 is formed in the first surface 111 of the carrier 110. A plurality of first pads 115 are formed on the first surface 111 around the chip cavity 114. A plurality of second pads 116 are formed on the second surface 112 of the carrier 110 where the second pads 116 are electrically connected to the corresponding first pads 115 through the plated through holes 113 or internal circuit of the carrier 110 (not shown in the figure). The image sensor chip 120 can be selected from a charged couple device (CCD), or a CMOS chip, which has an active surface 121 and a back surface 122. A plurality of bonding pads 123 and a sensing area are formed on the active surface 121 of the image sensor chip 120, preferably wetting layers 124, such as plated tin, are formed on the bonding pads 123. The back surface 121 of the image sensor chip 120 is attached to the carrier 110 by an adhesive layer 141 so that the image sensor chip 120 is located in the chip cavity 114. The transparent substrate 130 is a transparent glass, which has an inward surface 131 and an outward surface 132. A plurality of probe leads 133 are formed on the inward surface 131 and have a plurality of free tips 134, which may be fabricated by the micro-electro-mechanical-system (MEMS). In this embodiment, the probe leads 133 are cantilevered and elastic where the free tips 134 are bent away from the inward surface 131 of the transparent substrate 130 and are capable of electrically contacting the bonding pads 123 of the image sensor chip 120 with various thickness, i.e., another image sensor chip with a different thickness can still be disposed in the chip cavity 114 of the carrier 110 and still can be contacted by the same probe leads 133. Each probe lead 133 may have a terminal 135 fixed on the transparent substrate 130, for example, Au bumps. In the embodiment of the present invention, an anisotropic conductive paste 142 (ACP) or non-conductive paste (NCP) is disposed between the carrier 110 and the transparent substrate 130. When the transparent substrate 130 is adhered to the carrier 110 by curing the ACP 142, then the image sensor chip 130 is hermetically sealed, and the free tips 134 are electrically contacted to the bonding pads 123 of the image sensor chip 120, and the terminals 135 of the probe leads 133 are electrically connected to the first pads 115 of the carrier 110. Preferably, to assure good electrical connections between the terminals 135 of the probe leads 133 on the transparent substrate 130 and the first pads 115 of the carrier 110, reflowing the wetting layers 124 is performed. Accordingly, hermetic sealing of the image sensor chip 120 and electrical connection from the image sensor chip 120 to the carrier 110 through the transparent substrate 130 can be accomplished in the same process. In a more detailed structure, a plurality of solder balls 150 are placed on the second pads 116 of the carrier 110 for the transmission of image signals of the image sensor chip 110 to the external electronic devices.

Since the free tips 134 of the probe leads 133 are bent away from the inward surface 131 of the transparent substrate 130 and are suspended in the air, therefore, the free tips 134 are elastic. The probe leads 133 can offset the variations of the thickness of the image sensor chip 120 or the depth of the chip cavity 114 of the carrier 110. Unlike the conventional wire-bonding type image sensor packages, when the thickness of the image sensor chip 120 or the depth of the chip cavity 114 of the carrier 110 changes, the parameters of wire bonding have to be readjusted. Moreover, when the thickness of the image sensor chip 120 is close to the depth of the chip cavity 114 of the carrier 110, the free tips 134 of the probe leads 133 can stay close to the inward surface 131 of the transparent substrate 130. Unlike the conventional wire-bonding type image sensor packages, the bonding wires will be damaged by the transparent substrate 130 when the thickness of the image sensor chip 120 is close to the depth of the chip cavity 114 of the carrier 110.

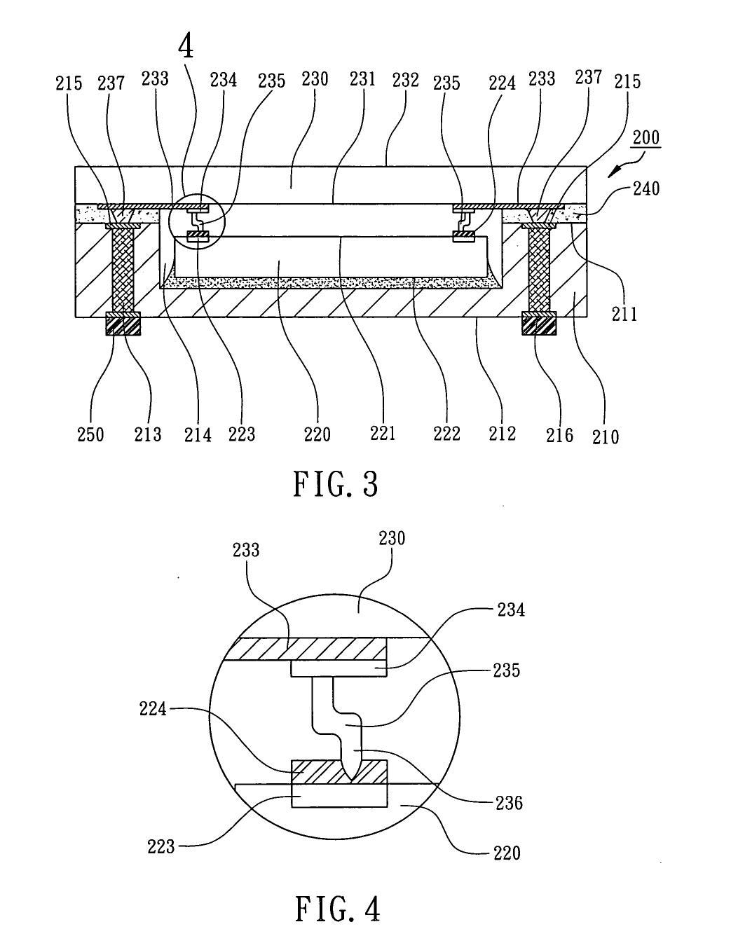

As shown in FIG. 3 and FIG. 4, an image sensor package 200 is disclosed according to in the second embodiment of the present invention. The package 200 comprises a carrier 210, an image sensor chip 220, and a transparent substrate 230. Therein the carrier 210 has a first surface 211, a second surface 212, a plurality of plated through holes 213, a chip cavity 214, a plurality of first pads 215, and a plurality of second pads 216, almost the same as the first embodiment. The image sensor chip 220 has an active surface 221, a back surface 222, and a plurality of bonding pads 223 on the active surface 221. Pre-solder materials 224 may be disposed on the bonding pads 223. The transparent substrate 230 has an inward surface 231 and an outward surface 232 where a plurality of traces 233 are formed on the inward surface 231. The traces 233 are conductive, made of indium tin oxide (ITO) or Au. Bumps 237 on one end of the traces 233 are electrically connected to the first pads 215 of the carrier 210 by an anisotropic conductive paste 240. Moreover, a bonding layer 234 and a plurality of probe leads 235 are formed on the other ends of the plurality of traces 233. The probe leads 235 have a plurality of free tips 236. In the present embodiment, the free tips 236 of the probe leads 235 are formed by wire-bonding plus plating. The electrical connections between the free tips 236 and the bonding pads 223 can be improved by the pre-solder materials 224 on the image sensor chip 220. The signals of the image sensor chip 220 can electrically connect to the first pads 215 through the probe leads 235, and traces 234. Therefore, the process of adhering the transparent substrate 230 to the carrier 210 will accomplish the hermetic sealing of the image sensor chip 220 and the electrical connections from the image sensor chip 220 to the carrier 210 through the transparent substrate 230. In this embodiment, solder 250 may be formed on the second pads 216.

The above description of embodiments of this invention is intended to be illustrative and not limiting. Other embodiments of this invention will be obvious to those skilled in the art in view of the above disclosure.

What is claimed is:

1. An image sensor package comprising:
a carrier having a first surface, a second surface, and a chip cavity in the first surface, wherein a plurality of first pads are formed on the first surface around the chip cavity;
an image sensor chip disposed in the chip cavity and having an active surface and a back surface, wherein a plurality of bonding pads are formed on the active surface; and
a transparent substrate including a plurality of probe leads, wherein the probe leads have a plurality of free tips;
when the transparent substrate is adhered to the carrier, the image sensor chip is hermetically sealed, and the free tips are electrically contacted to the bonding pads of the image sensor chip, and the probe leads are electrically connected to the first pads of the carrier.

2. The image sensor package of claim 1, wherein the probe leads are cantilevered.

3. The image sensor package of claim 1, wherein the free tips of the probe leads are formed by wire-bonding plus plating.

4. The image sensor package of claim 1, wherein the probe leads are MEMS (micro-electro-mechanical-system) probes.

5. The image sensor package of claim 1, further comprising an ACP (anisotropic conductive paste) or NCP (non-conductive paste) disposed between the carrier and the transparent substrate.

6. The image sensor package of claim 1, further comprising a plurality of pre-solder materials formed on the bonding pads.

7. The image sensor package of claim 1, wherein a plurality of wetting layers are formed on the bonding pads.

8. The image sensor package of claim 1, wherein the carrier has a plurality of second pads on the second surface.

9. The image sensor package of claim 8, further comprising a plurality of solder balls on the second pads.

10. The image sensor package of claim 8, wherein the carrier has a plurality of plated through holes between the first pads and the second pads.
